(19) United States
(12) Patent Application Publication
(10) Pub. No.: US 2025/0077767 A1
(43) Pub. Date: Mar. 6, 2025

(54) METHOD, SYSTEM, DEVICE, AND MEDIUM FOR QUESTIONNAIRE GENERATION

(71) Applicant: Beijing Zitiao Network Technology Co., Ltd., Beijing (CN)

(72) Inventors: Xuqi Fang, Beijing (CN); Haochun Liao, Beijing (CN); Andi Guan, Beijing (CN); Fanxin Deng, Beijing (CN); Yaozong Liu, Beijing (CN)

(21) Appl. No.: 18/818,401

(22) Filed: Aug. 28, 2024

(30) Foreign Application Priority Data
Aug. 31, 2023 (CN) 202311120113.0

(51) Int. Cl. G06F 40/186; G06F 3/0482

(52) U.S. Cl. CPC G06F 40/186; G06F 3/0482

(57) ABSTRACT

The present application provides a questionnaire generation method and system, a device, and a medium. The method includes: in response to a generation triggering operation for a questionnaire generation page, obtaining text to be processed inputted by a user in a dialog window, wherein the dialog window is used for receiving content inputted by the user, and the text to be processed is used for instructing to generate a target questionnaire; generating at least one candidate question according to the text to be processed, and presenting the at least one candidate question on the questionnaire generation page, wherein the candidate question includes a title and an answer option corresponding to the title; and in response to a confirming operation for a target candidate question among the at least one candidate question, using the target candidate question as at least one question of the target questionnaire.

### CROSS-REFERENCE TO RELATED APPLICATION(S)

This application claims priority to Chinese Application No. 202311120113.0, filed on Aug. 31, 2023, the disclosure of which is incorporated herein by reference in its entity.

### FIELD

The present application relates to the field of computers technologies, and in particular, to a method, system, an electronic device, and a computer-readable storage medium for questionnaire generation.

### BACKGROUND

A questionnaire means a series of questions designed to collect information on users' attitudes, values, points of view, and other aspects of a specific topic. With the continuous development of computer technology, questionnaires have gradually shifted from offline distribution to online distribution, and tools for generating questionnaires have emerged, such as a questionnaire platform, a questionnaire system, and other questionnaire generation tools.

Specifically, a user can use the questionnaire generation tool to formulate a plurality of questions related to the specific topic, thereby generating a questionnaire. However, by the above method, the user needs to consume high learning cost. Furthermore, the user needs to revise the questions in the questionnaire, so that the questionnaire generation efficiency is low.

### SUMMARY

The present application provides a questionnaire generation method. The method may generate questions according to text to be processed that is inputted by a user, thus achieving automatic generation of a questionnaire. The method reduces the learning cost of a user using a questionnaire generation tool and improves the questionnaire generation efficiency. The present application further provides a system corresponding to the above method, an electronic device, a computer-readable storage medium, and a computer program product.

In a first aspect, the present application provides a questionnaire generation method. The method includes:
obtaining, in response to a generation triggering operation for a questionnaire generation page, text to be processed inputted by a user in a dialog window, wherein the dialog window is used for receiving content inputted by the user, and the text to be processed is used for instructing to generate a target questionnaire;
generating at least one candidate question according to the text to be processed, and presenting the at least one candidate question on the questionnaire generation page, wherein the candidate question includes a title and an answer option corresponding to the title; and
in response to a confirming operation for a target candidate question among the at least one candidate question, using the target candidate question as at least one question of the target questionnaire.

In some possible implementations, the obtaining, in response to a generation triggering operation for a questionnaire generation page, text to be processed inputted by a user in a dialog window includes:
obtaining, in response to a triggering operation for the dialog window in the questionnaire generation page, the text to be processed inputted by the user in the dialog window; or
presenting the dialog window on the questionnaire generation page in response to a triggering operation for a dialog control on the questionnaire generation page; and
obtaining the text to be processed inputted by the user in the dialog window.

In some possible implementations, generating at least one candidate question according to the text to be processed includes:
inputting the text to be processed to a question generation model, and generating the at least one candidate question.

In some possible implementations, presenting the at least one candidate question on the questionnaire generation page includes:
presenting the title of the at least one candidate question on the questionnaire generation page, and presenting the answer option, corresponding to the title, of the at least one candidate question on the questionnaire generation page according to a title type of the title and a presentation rule corresponding to the title type.

In some possible implementations, the method further includes:
generating a target table according to the target questionnaire, wherein the target table is used for compiling questionnaire results of the target questionnaire, and fields of the target table correspond to the questions of the target questionnaire.

In some possible implementations, the fields of the target table correspond to the questions of the target questionnaire, includes:
field names of the fields in the target table correspond to the titles of the questions in the target questionnaire; and
field types of the fields in the target table correspond to title types of the questions in the target questionnaire.

In some possible implementations, the method further includes:
updating, in response to a revise operation for the field name of a target field in the target table, a title of a target question, corresponding to the target field, in the target questionnaire; or,
updating, in response to a revise operation for a field attribute of a target field in the target table, an answer option of the target question, corresponding to the target field, in the target questionnaire.

In some possible implementations, obtaining, in response to a generation triggering operation for a questionnaire generation page, text to be processed inputted by a user in a dialog window includes:
in response to the generation triggering operation for the questionnaire generation page, obtaining first text to be processed inputted by the user in a first dialog window, wherein the first text to be processed is used for instructing to generate a target questionnaire, and the first dialog window is located in a first region of the questionnaire generation page;
generating at least one candidate question according to the text to be processed, and presenting the at least one candidate question on the questionnaire generation page includes:
generating at least one first candidate question according to the first text to be processed, and presenting the at least one first candidate question on the questionnaire generation page;
the method further includes:
in response to the generation triggering operation for the questionnaire generation page, obtaining second text to be processed inputted by the user in a second dialog window, wherein the second text to be processed is used for instructing to generate candidate questions, and the second dialog window is located in a second region of the questionnaire generation page; and
generating a second candidate question according to the second text to be processed and the at least one first candidate question.

In some possible implementations, the method further includes:
regenerating, in response to a retry operation for the at least one candidate question in the dialog window, the at least one candidate question, and presenting the at least one regenerated question on the questionnaire generation page.

In some possible implementations, regenerating, in response to a retry operation for the at least one candidate question in the dialog window, the at least one candidate question includes:
regenerating, in response to a triggering operation for a retry control in the dialog window, the at least one candidate question; or,
obtaining third text to be processed inputted by the user in the dialog window, wherein the third text to be processed is used for instructing to regenerate the candidate question; and
regenerating the at least one candidate question according to the third text to be processed.

In a second aspect, the present application provides a system for questionnaire generation. The system includes:
an obtaining module, configured to obtain, in response to a generation triggering operation for a questionnaire generation page, text to be processed inputted by a user in a dialog window, wherein the dialog window is used for receiving content inputted by the user, and the text to be processed is used for instructing to generate a target questionnaire;
a generation module, configured to generate at least one candidate question according to the text to be processed;
a presentation module, configured to present the at least one candidate question on the questionnaire generation page, wherein the candidate question includes a title and an answer option corresponding to the title; and
a determining module, configured to use, in response to a confirming operation for a target candidate question among the at least one candidate question, the target candidate question as at least one question of the target questionnaire.

In some possible implementations, the obtaining module is specifically configured to:
obtain, in response to a triggering operation for the dialog window in the questionnaire generation page, the text to be processed inputted by the user in the dialog window; or
present the dialog window on the questionnaire generation page in response to a triggering operation for a dialog control on the questionnaire generation page; and
obtain the text to be processed inputted by the user in the dialog window.

In some possible implementations, the generation module is specifically configured to:
input the text to be processed to a question generation model, and generate the at least one candidate question.

In some possible implementations, the presentation module is specifically configured to:
present the title of the at least one candidate question on the questionnaire generation page, and present the answer option, corresponding to the title, of the at least one candidate question on the questionnaire generation page according to a title type of the title and a presentation rule corresponding to the title type.

In some possible implementations, the generation module is further configured to:
generate a target table according to the target questionnaire, wherein the target table is used for compiling questionnaire results of the target questionnaire, and fields of the target table correspond to the questions of the target questionnaire.

In some possible implementations, the generation module is specifically configured to achieve that:
field names of the fields in the target table correspond to the titles of the questions in the target questionnaire; and
field types of the fields in the target table correspond to title types of the questions in the target questionnaire.

In some possible implementations, the system further includes:
an update module, configured to: update, in response to a revise operation for the field name of a target field in the target table, a title of a target question, corresponding to the target field, in the target questionnaire; or, update, in response to a revise operation for a field attribute of a target field in the target table, an answer option of a target question, corresponding to the target field, in the target questionnaire.

In some possible implementations, the obtaining module is specifically configured to:
in response to the generation triggering operation for the questionnaire generation page, obtain first text to be processed inputted by the user in a first dialog window, wherein the first text to be processed is used for instructing to generate a target questionnaire, and the first dialog window is located in a first region of the questionnaire generation page;
the generation module is specifically configured to:
generate at least one first candidate question according to the first text to be processed, and present the at least one first candidate question on the questionnaire generation page;
the obtaining module is further configured to:
in response to the generation triggering operation for the questionnaire generation page, obtain second text to be processed inputted by the user in a second dialog window, wherein the second text to be processed is used for instructing to generate candidate questions, and the second dialog window is located in a second region of the questionnaire generation page; and
the generation module is further configured to:
generate a second candidate question according to the second text to be processed and the at least one first candidate question.

In some possible implementations, the generation module is further configured to:
regenerate in response to a retry operation for the at least one candidate question in the dialog window, the at least one candidate question, and present the at least one regenerated question on the questionnaire generation page.

In some possible implementations, the generation module is specifically configured to:
regenerate, in response to a triggering operation for a retry control in the dialog window, the at least one candidate question; or,
obtain third text to be processed inputted by the user in the dialog window, wherein the third text to be processed is used for instructing to regenerate the candidate question; and
regenerate the at least one candidate question according to the third text to be processed.

In a third aspect, the present application provides an electronic device. The electronic device includes a processor and a memory. The processor communicates with the memory. The processor is configured to execute instructions stored in the memory to cause the device to perform the questionnaire generation method as described in the first aspect or any implementation of the first aspect.

In a fourth aspect, the present application provides a computer-readable storage medium, having instructions stored therein. The instructions instruct an electronic device to perform the questionnaire generation method as described in the first aspect or any implementation of the first aspect.

In a fifth aspect, the present application provides a computer program product including instructions. When the computer program product is run on an electronic device, the electronic device is caused to perform the questionnaire generation method as described in the first aspect or any implementation of the first aspect.

The present application can be further combined to provide more implementations based on the implementations provided in all the above aspects.

It can be seen from the above technical solutions that the present application has the following advantages:

The present application provides a questionnaire generation method. The method includes: in response to a generation triggering operation for a questionnaire generation page, obtaining text to be processed inputted by a user in a dialog window, wherein the dialog window is used for receiving content inputted by the user, and the text to be processed is used for instructing to generate a target questionnaire; then, generating at least one candidate question according to the text to be processed, and presenting at least one question of the target questionnaire on the questionnaire generation page, wherein the candidate question includes a candidate title and an answer option corresponding to the candidate title; and in response to a confirming operation for a target candidate question among the at least one candidate question, using the target candidate question as at least one question of the target questionnaire.

The method supports automatically generating questions in a questionnaire. By providing a dialog window on a questionnaire generation page, text to be processed inputted by a user is obtained, and an intention of the user on a questionnaire to be generated is recognized; candidate questions are generated for selection by the user; and when the user confirms that the candidate questions meet a requirement, questions in the questionnaire are determined. In this way, the learning cost of a user using a questionnaire generation tool is reduced, and the questionnaire generation efficiency is improved.

### BRIEF DESCRIPTION OF THE DRAWINGS

In order to describe the technical method of the embodiments of the present application more clearly, the following briefly describes the accompanying drawings required in the embodiments.

FIG. 1 is a flowchart of a questionnaire generation method according to an embodiment of the present application;

FIG. 2A to FIG. 2F are schematic diagrams of a questionnaire generation page according to an embodiment of the present application;

FIG. 3 is a schematic structural diagram of a questionnaire generation system according to an embodiment of the present application; and

FIG. 4 is a schematic structural diagram of an electronic device according to an embodiment of the present application.

### DETAILED DESCRIPTION OF EMBODIMENTS

The terms “first” and “second” in the embodiments of the present application are used for descriptive purposes only and are not to be construed as indicating or implying relative importance or to implicitly indicate the number of technical features indicated. Thus, features defined as “first” and “second” explicitly or implicitly include one or more of the features.

Some technical terms in the embodiments of the present application are first introduced.

A questionnaire means a series of questions designed to collect information on users' attitudes, values, points of view, and other aspects of a specific topic. In other words, a questionnaire can be used for collecting information. The questionnaire can typically include a plurality of different types of questions, such as open-ended questions or closed-ended questions. The closed-ended questions can further specifically include choice questions, scoring questions, and the like.

With the continuous development of computer technology, questionnaires have gradually shifted from offline distribution to online distribution, and tools for generating questionnaires have emerged. The tools for generating questionnaires may be a questionnaire platform and a questionnaire system. In some examples, the above questionnaire generation tool may be a standalone software system, such as a standalone application (APP) or a mini program. In some other examples, the above questionnaire generation tool may be deployed in other systems, such as on a service platform, serving as a system module of the service platform to provide questionnaire generation services for users.

In a process that a user uses the questionnaire generation tool to generate a questionnaire, the user can use the questionnaire generation tool to formulate a plurality of questions related to the specific topic, thereby generating a questionnaire. Specifically, the user may set a plurality of titles of questions according to a questionnaire topic, and then set answer options for the plurality of questions according to title types. For example, for a question which is in the title type of multiple-choice question, a plurality of options is set; and for a question which is in the title type of scoring question, a representation mode of a score is set.

However, by the above method, the user needs to consume high learning cost. Furthermore, the user needs to manually set and revise the questions in the questionnaire, so that the questionnaire generation efficiency is low.

In view of this, the present application provides a questionnaire generation method. The method includes: in response to a generation triggering operation for a questionnaire generation page, obtaining text to be processed inputted by a user in a dialog window, wherein the dialog window is used for receiving content inputted by the user, and the text to be processed is used for instructing to generate a target questionnaire; then, generating at least one candidate question according to the text to be processed, and presenting at least one question of the target questionnaire on the questionnaire generation page, wherein the candidate question includes a candidate title and an answer option corresponding to the candidate title; and in response to a confirming operation for a target candidate question among the at least one candidate question, using the target candidate question as at least one question of the target questionnaire.

The method supports automatically generating questions in a questionnaire. By providing a dialog window on a questionnaire generation page, text to be processed inputted by a user is obtained, and an intention of the user on a questionnaire to be generated is recognized; candidate questions are generated for selection by the user; and when the user confirms that the candidate questions meet a requirement, questions in the questionnaire are determined. In this way, the learning cost of a user using a questionnaire generation tool is reduced, and the questionnaire generation efficiency is improved.

For ease of understanding the technical solutions of the embodiments of the present application, the following will make an explanation in conjunction with the accompanying drawings.

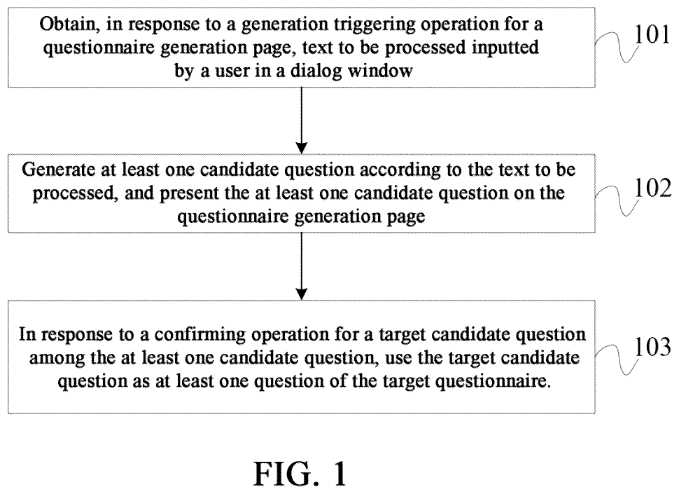

FIG. 1 is a flowchart of a questionnaire generation method according to an embodiment of the present application. The method specifically includes:

S101: In response to a generation triggering operation for a questionnaire generation page, obtaining text to be processed inputted by a user in a dialog window.

The questionnaire generation page is a page used for generating a questionnaire. In some embodiments, the questionnaire generation page may be a graphical user interface (GUI). In some other embodiments, the questionnaire generation page may be a command user interface (CUI).

According to different application scenarios, the questionnaire generation page may have different representation forms. For example, when a user uses a standalone questionnaire generation tool for questionnaire generation, the questionnaire generation page may be a page loaded in a client corresponding to the questionnaire generation tool. For another example, when a user uses a questionnaire generation tool deployed in another system (such as a service platform) for questionnaire generation, the questionnaire generation page may be a page loaded in a client corresponding to the another system. For still another example, when a user uses a questionnaire generation tool that may be used online for questionnaire generation, the questionnaire generation page may be a page presented in a browser.

The generation triggering operation is an operation that triggers questionnaire generation. According to different triggering modes, the generation triggering operation may be different. For example, the generation triggering operation may include one or more of an operation of clicking on a control with a mouse, an operation of touching a control, a shortcut key operation, or a voice instruction triggering operation.

The dialog window is used for receiving content inputted by a user. For example, the dialog window may receive content inputted by a user in the form of a chatting robot, thereby providing a questionnaire generation service for the user.

In some embodiments, the questionnaire generation page may directly present the dialog window. At this time, in response to the triggering operation for the dialog window in the questionnaire generation page, the text to be processed inputted by the user in the dialog window may be obtained. In some other embodiments, the questionnaire generation page may not directly present the dialog window, but only present a dialog control. At this time, the dialog window may be presented on the questionnaire generation page in response to a triggering operation for the dialog control on the questionnaire generation page, and the text to be processed inputted by the user in the dialog window is obtained.

This embodiment of the present application supports a user to enter the text to be processed through different modes. For example, a user may enter text through a keyboard, and the inputted text is the text to be processed. For another example, when a device used by a user supports voice inputting, the user may enter a voice too. When the voice inputted by the user is converted into text, the text to be processed may be obtained.

The text to be processed may be used for instructing to generate a target questionnaire. A questionnaire is a series of questions designed for a specific topic. The target questionnaire may be a questionnaire to be generated that meets a need of a user. Usually, the text to be processed may be text that is described by the user in a natural language and is used for representing the need of the target questionnaire. For example, the text to be processed may include a topic of the target questionnaire, the number of questions in the target questionnaire, and other needs.

S102: At least one candidate question is generated according to the text to be processed, and the at least one candidate question is presented on the questionnaire generation page.

The candidate question may include a title and an answer option corresponding to the title. Specifically, the title may have different title types (also referred to as question types), including but not limited to question-answer questions, single-choice questions, multiple-choice question, scoring questions, true or false questions, and the like. Correspondingly, the answer option corresponding to the title may have different representation forms according to different title types. For example, when the title type indicates a question-answer question, the answer option can be a text box instructing a user to enter an answer. For another example, when the title type indicates a single-choice question or multiple-choice question, the answer option corresponding to the title can be a plurality of options for selection by a user. For still another example, when the title type indicates a true or false question, the answer option corresponding to the title may be “Yes” and “No” buttons.

In a specific implementation, natural language processing may be performed on the text to be processed to recognize the need of the user for the target questionnaire, thereby generating the at least one candidate question. The natural language processing (NLP) means a technology for interaction and communication with a machine by using a natural language used in human communication.

In some possible implementations, the text to be processed may be input to a question generation model, and the at least one candidate question is generated. The question generation model can be a model with a semantic understanding and analysis function or a model with a natural language processing capability, such as a deep learning model that is trained using a large amount of text data.

In some embodiments, the question generation model may be a model deployed in the questionnaire generation tool. The at least one candidate question may be directly generated by inputting the text to be processed into the question generation model. In some other embodiments, the question generation model may be an external model. After the text to be processed is obtained, the at least one candidate question may be generated by calling the question generation model.

In this embodiment of the present application, an artificial intelligence technology (such as the question generation model) is connected into the questionnaire generation tool, so that the questionnaire generation tool has the natural language processing capability. In this way, the candidate questions may be generated solely through a natural language inputted by the user, and the user does not need to manually add the questions.

Considering that the generated candidate questions may not meet the need of the user, in this embodiment of the present application, after the at least one candidate question is generated, the at least one candidate question may be presented on the questionnaire generation page for question confirmation by the user.

In a specific implementation, the title of the at least one candidate question may be presented on the questionnaire generation page, and the answer option, corresponding to the title, of the at least one candidate question may be presented on the questionnaire generation page according to a title type of the title and a presentation rule corresponding to the title type.

In other words, this embodiment of the present application supports presenting the candidate questions in different presentation modes. Specifically, when the title type indicates a question-answer question, the presentation rule can be to present a text box. When the title type indicates a single-choice question or a multiple-choice question, the presentation rule can be to present a plurality of options. For example, the plurality of options and their corresponding check boxes can be presented on the questionnaire generation page in the form of a list. When the title type indicates a scoring question, the presentation rule can be to present a score mark. For example, a plurality of blank score marks are presented on the questionnaire generation page. A user can give a score by selecting the score marks. When there are five blank score marks, if the user selects three score marks, the score will be 60 points; and if the user selects four score marks, the score will be 80 points.

S103: In response to a confirming operation for a target candidate question among the at least one candidate question, the target candidate question is used as at least one question of the target questionnaire.

The confirming operation is an operation for confirming that the candidate question is a question in the target questionnaire. In other words, a user may trigger the confirming operation on a candidate question that meet the need of the target questionnaire, thereby using the candidate question as a question in the target questionnaire.

In some embodiments, the target candidate question can be one or more candidate questions. A user may perform the confirming operation separately to select the target candidate question that meets the need of the user from the at least one candidate question in the target questionnaire, and use the target candidate question that meets the need of the user as the at least one question in the target questionnaire. For example, the candidate questions can be candidate question 1, candidate question 2, candidate question 3, and candidate question 4. By presenting the above candidate questions on the questionnaire generation page, the user performs the confirming operation separately on the candidate questions and selects candidate question 1, candidate question 2, and candidate question 4 which meet the need of the user as the target candidate questions. In this way, the questions of the target questionnaire include candidate question 1, candidate question 2, and candidate question 4, but do not include candidate question 3.

In some other embodiments, a user may perform a one-time confirming operation on all the candidate questions, namely, perform the confirming operation on all the currently generated candidate questions, so as to use all the candidate questions as the questions in the target questionnaire, or so as not to use all the candidate questions as the questions in the target questionnaire. For example, the candidate questions may be candidate question 1, candidate question 2, candidate question 3, and candidate question 4. By presenting the above candidate questions on the questionnaire generation page, the user may make judgments on these candidate questions. When all the candidate questions meet the need of the user, the confirming operation may be triggered on the candidate questions, so that candidate questions 1, candidate question 2, candidate question 3, and candidate question 4 are all used as the questions in the target questionnaire. When the candidate questions do not meet the need of the user, the confirming operation may not be performed on the candidate questions or an abandoning operation may be triggered on the candidate questions, instead of using candidate questions 1, candidate question 2, candidate question 3, and candidate question 4 as the questions in the target questionnaire.

Further, this embodiment of the present application supports regeneration for the candidate questions. In a specific implementation, when the at least one candidate question does not meet the need of the user, the user may trigger a retry operation on the at least one candidate question in the dialog window. The at least one candidate question is generated in response to a retry operation for the at least one candidate question in the dialog window, and the at least one regenerated question is presented on the questionnaire generation page.

Similar to the confirming operation for the at least one candidate question, in some embodiments, the retry operation may be performed separately on one or more candidate questions among the candidate questions to regenerate the corresponding candidate questions. For example, the candidate questions may be candidate question 1, candidate question 2, candidate question 3, and candidate question 4. By presenting the above candidate questions on the questionnaire generation page, a user may trigger the retry operation on candidate question 1 and candidate question 2 which do not meet the need of the user in the dialog window. In response to the retry operation, candidate question 1 and candidate question 2 may be regenerated.

In some other embodiments, a user may perform the retry operation separately on all the candidate questions to regenerate all the candidate questions. For example, the candidate questions may be candidate question 1, candidate question 2, candidate question 3, and candidate question 4. By presenting the above candidate questions on the questionnaire generation page, the user may make judgments on these candidate questions. When all the candidate questions do not meet the need of the user, the user may perform the retry operation on all the candidate questions. In this way, candidate question 1, candidate question 2, candidate question 3, and candidate question 4 are regenerated.

In this embodiment of the present application, the user may trigger the retry operation in different ways. In some possible implementations, the dialog window may present a retry control, and the user may trigger the retry control. In this way, in response to a triggering operation for the retry control in the dialog window, at least one candidate question is regenerated, thereby quickly achieving the regeneration of the candidate questions through the retry control.

In some other possible implementations, the user may input third text to be processed. The third text to be processed may be used for indicating the regeneration of the candidate questions. In this way, the third text to be processed inputted by the user in the dialog window is obtained, and the at least one candidate question is regenerated according to the third text to be processed, thereby supporting the user to regenerate the candidate questions by inputting a natural language.

Further, this embodiment of the present application further supports question generation by using a candidate question as a granularity. Specifically, the generation of the target questionnaire (i.e. the candidate questions of the target questionnaire) or the generation of a single candidate question may be performed according to different regions (i.e. a position where the dialog window is located) where the triggering operation is generated on the questionnaire generation page.

In some possible implementations, in response to the generation triggering operation for the questionnaire generation page, first text to be processed inputted by the user in a first dialog window is obtained. The first text to be processed is used for instructing to generate a target questionnaire, and the first dialog window is located in a first region of the questionnaire generation page. Then, at least one first candidate question is generated according to the first text to be processed, and the at least one first candidate question is presented on the questionnaire generation page. Next, in response to the generation triggering operation for the questionnaire generation page, second text to be processed inputted by the user in a second dialog window is obtained. The second text to be processed is used for instructing to generate candidate questions, and the second dialog window is located in a second region of the questionnaire generation page. Then, a second candidate question is generated according to the second text to be processed and the at least one first candidate question.

In other words, this embodiment of the present application recognizes the intention of the user according to different regions where the dialog window is located, and determines to generate an entire target questionnaire or generate a single candidate question. When the user intends to instruct to generate a single candidate question, natural language processing may be performed in conjunction with the second text to be processed inputted by the user and the existing candidate questions, thereby generating the second candidate question that meets the need of the user.

After the questions of the target questionnaire are determined, a target table may be generated according to the target questionnaire. The target table may be used for compiling questionnaire results of the target questionnaire, and fields of the target table correspond to the questions of the target questionnaire.

In a specific implementation, field names of the fields in the target table may correspond to the titles of the questions in the target questionnaire; and field types of the fields in the target table may correspond to title types of the questions in the target questionnaire. In other words, the titles of the questions in the target questionnaire may be converted to the field names of the fields in the target table, and the titles types of the questions in the target questionnaire may be converted to the field types of the fields in the target table. For example, a question with the title type indicating a multiple-choice question may be converted into a multiple-choice field. At this time, a field attribute of the field may include a plurality of options. For another example, a question with the title type indicating a scoring question may be converted into a scoring field. At this time, a field attribute of the field may include a score.

For ease of the compiling of the questionnaire results, the target table may further include a field used for compiling the questionnaire results, such as a field used for compiling submitters (i.e. a user answering the target questionnaire) and a field used for compiling submission time (i.e. time when the target questionnaire is answered). In this way, when a user answers the target questionnaire, the questionnaire results may be stored in the corresponding fields of the target table, achieving the compiling of the questionnaire results.

Further, this embodiment of the present application further supports a user to revise the target questionnaire by revising the target table. In specific implementation, in response to a revise operation for the field name of a target field in the target table, the title of a target question, corresponding to the target field, in the target questionnaire is updated; or, in response to a revise operation for a field attribute of a target field in the target table, the target questionnaire modification operation is updated and the answer option of a target question, corresponding to the target field, in the target questionnaire is updated. In other words, the target questionnaire and the target table are in bidirectional association. When a user revises a field in the target table, the title at the corresponding position in the target questionnaire will be correspondingly revised too, making it easier to manage the questionnaire.

Based on the above description, this embodiment of the present application provides a questionnaire generation method. The method includes: in response to a generation triggering operation for a questionnaire generation page, obtaining text to be processed inputted by a user in a dialog window, wherein the dialog window is used for receiving content inputted by the user, and the text to be processed is used for instructing to generate a target questionnaire; then, generating at least one candidate question according to the text to be processed, and presenting at least one question of the target questionnaire on the questionnaire generation page, wherein the candidate question includes a candidate title and an answer option corresponding to the candidate title; and in response to a confirming operation for a target candidate question among the at least one candidate question, using the target candidate question as at least one question of the target questionnaire.

The method supports automatically generating questions in a questionnaire. By providing a dialog window on a questionnaire generation page, text to be processed inputted by a user is obtained, and an intention of the user on a questionnaire to be generated is recognized; candidate questions are generated for selection by the user; and when the user confirms that the candidate questions meet a requirement, questions in the questionnaire are determined. In this way, the learning cost of a user using a questionnaire generation tool is reduced, and the questionnaire generation efficiency is improved.

Next, the questionnaire generation method provided by the present application will be explained in conjunction with specific application scenarios.

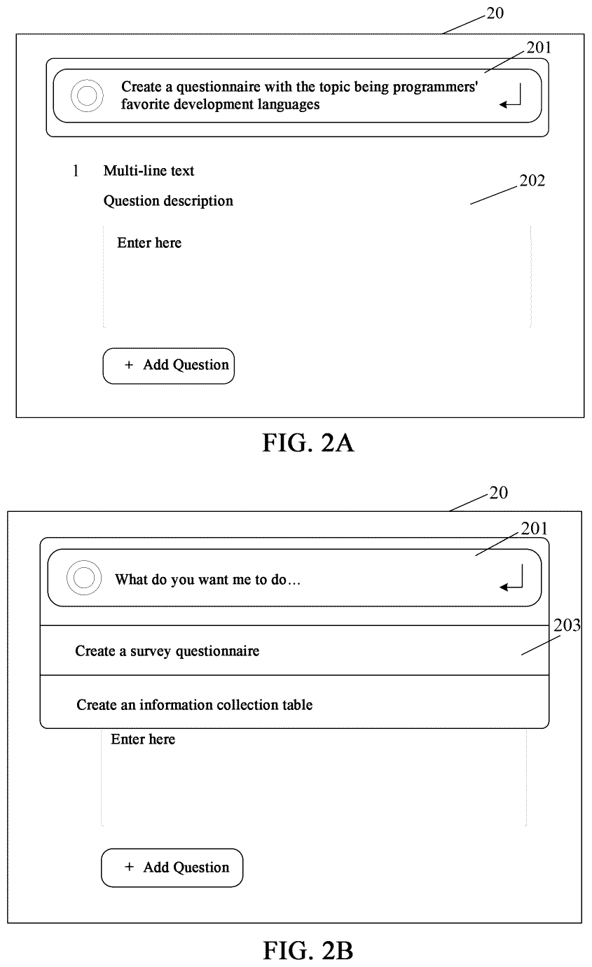

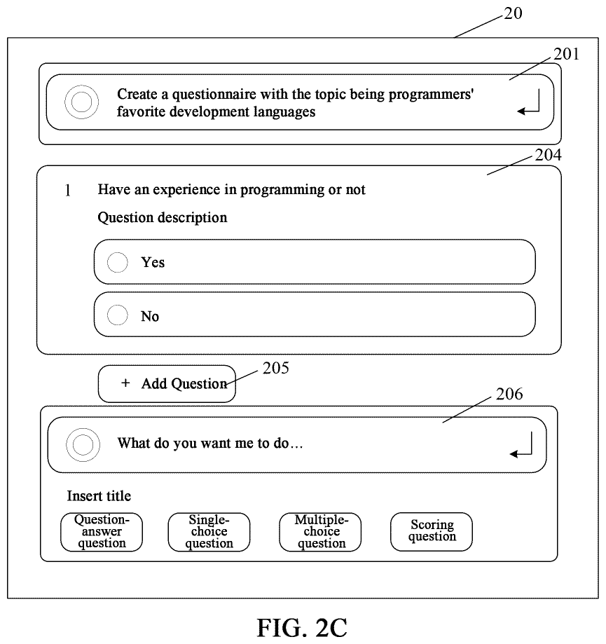

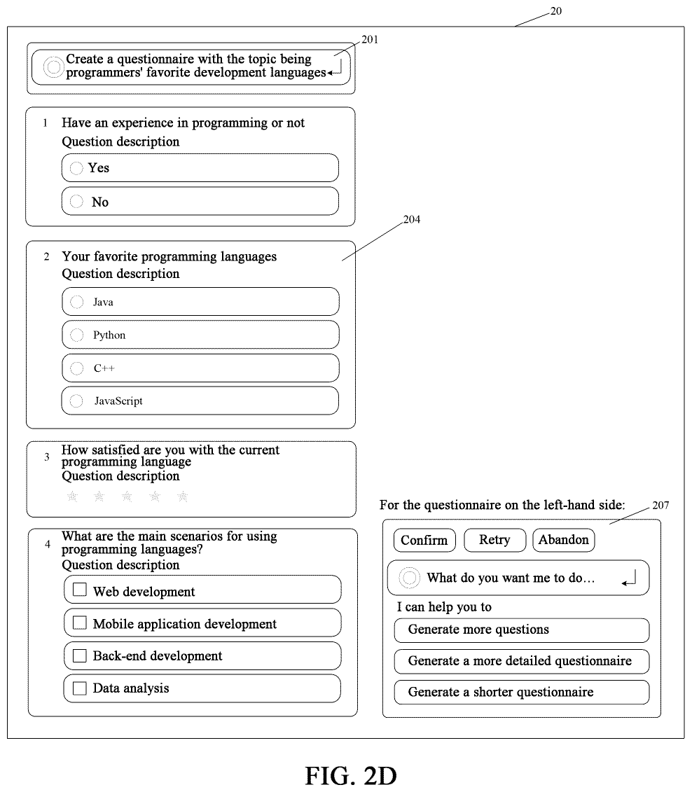

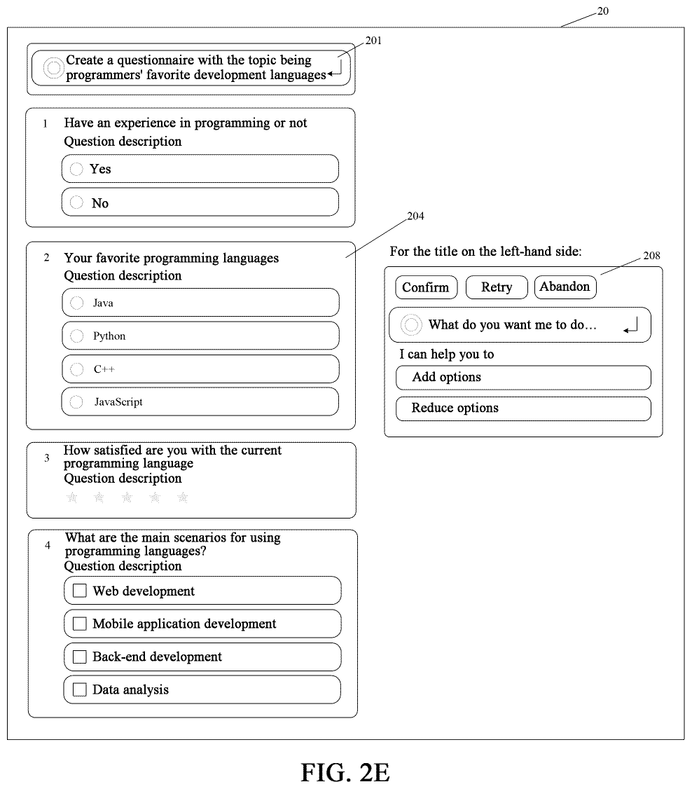

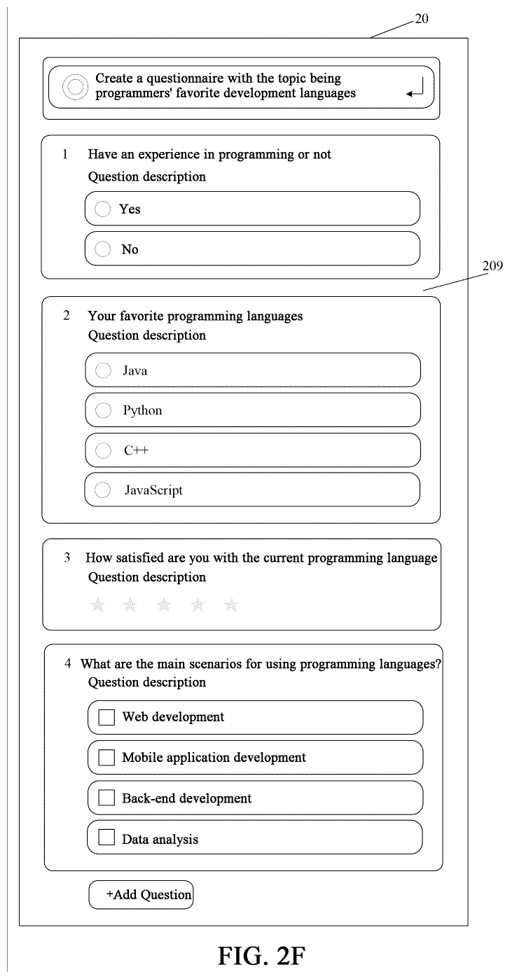

FIG. 2A to FIG. 2F are schematic diagrams of a questionnaire generation page according to an embodiment of the present application. The questionnaire generation page may be a page in a questionnaire generation tool. A user may generate a target questionnaire through the questionnaire generation page.

As shown in FIG. 2A, the questionnaire generation page 20 includes a dialog window 201 and a question adding region 202. The dialog window 201 is usually located at an upper half part of the questionnaire generation page 20, and the dialog window 201 is used for triggering a questionnaire generation operation and obtaining text to be processed. Specifically, a user may click on the dialog window 201 to generate a generation triggering operation. Next, the user enters text to be processed into the dialog window 201. The text to be processed may be used for instructing to generate a target questionnaire. For example, the text to be processed may be “Create a questionnaire with the topic being programmers' favorite development languages”. In this way, the user may input a natural language in the dialog window 201 to achieve the automatic generation of the questionnaire.

In some possible implementations, the questionnaire generation page 20 may not directly present the dialog window 201, but only present a dialog control. When the user triggers the dialog control, the dialog window 201 is presented to obtain the text to be processed inputted by the user in the dialog window 201.

The question adding region 202 is usually located below the dialog window 201, and the question adding region 202 is used for manually adding questions. In some embodiments, the user may choose to manually add questions instead of using the automatic questionnaire generation capability provided by the dialog window 201. At this time, the user may add a title in the question adding region 202, such as adding a question description and a question options. In this way, the user can generate a questionnaire by manually adding questions in the question adding region 202.

In some possible implementations, in response to a generation triggering operation on the questionnaire generation page, at least one piece of auxiliary text may be presented, and the auxiliary text is used for assisting the user in entering the text to be processed. As shown in FIG. 2B, the questionnaire generation page 20 includes an auxiliary text presentation region 203. The auxiliary text presentation region 203 is usually located below the dialog window 201. For example, the auxiliary text presentation region 203 may present auxiliary text in the form of a pull-down menu. Specifically, when a user clicks on the dialog window 201, in response to the generation triggering operation for the questionnaire generation page 20, at least one piece of auxiliary text may be presented in the auxiliary text presentation region 203. For example, the auxiliary text may be “Create a survey questionnaire” or “Create an information collection table”. The user may perform a selection operation on the auxiliary text presented in the auxiliary text presentation region 203, so that the user may input the text to be processed based on the auxiliary text, and the questionnaire generation efficiency can be improved. For example, after the user selects the auxiliary text “Create an information collection table”, the user may input the text to be processed based on the auxiliary text. The final text to be processed may be “Create an information collection table to collect programmers' preferences for different development languages”.

This embodiment of the present application supports the automatic generation of an entire target questionnaire or a single candidate question. As shown in FIG. 2C, the questionnaire generation page 20 includes a first dialog window 201, a candidate question presentation region 204, a question adding control 205, and a second dialog window 206. The first dialog window 201 is used for obtaining the first text to be processed, and the first text to be processed is used for instructing to generate the target questionnaire. For example, the first text to be processed may be “Create a questionnaire with the topic being programmers' favorite development languages”.

The candidate question presentation region 204 is used for presenting candidate questions. Specifically, at least one candidate question may be generated according to the first text to be processed, and the candidate question is presented in the candidate question presentation region 204. For example, the candidate question may be “Have experience in programming or not”. The title type of the candidate question indicates a single-choice question, and a corresponding option can be “Yes” or “No”.

The question adding control 205 is used for triggering a question adding operation. Specifically, a user may click on the question adding control 205 to trigger an adding operation for candidate questions. After the adding operation for the candidate questions, a second dialog window 206 is presented.

The second dialog window 206 is used for obtaining second text to be processed, and the second text to be processed is used for instructing to generate a candidate question. In this way, a candidate question may be further generated according to the second text to be processed and the existing candidate questions (i.e. the candidate questions presented in the candidate question presentation region 204), achieving the automatic generation of a single candidate question. Further, the second dialog window 206 may include at least one auxiliary control. The auxiliary control may be used for assisting the user in entering the second text to be processed. For example, the auxiliary control may be used for indicating the title type of the candidate question, and may specifically include an auxiliary control indicating that the title type is a question-answer question, an auxiliary control indicating that the title type is a single-choice question, an auxiliary control indicating that the title type is a multiple-choice question, and an auxiliary control indicating that the title type is a scoring question. The user may select the auxiliary control and enter the second text to be processed based on the title type indicated by the auxiliary control, thereby improving the efficiency of generating candidate questions.

After the candidate questions of the target questionnaire are generated, the user may process all the candidate questions for the target questionnaire. As shown in FIG. 2D, the questionnaire generation page 20 includes a dialog window 201, a candidate question presentation region 204, and a questionnaire processing region 207. The questionnaire processing region 207 is used for processing all the candidate questions, such as determining all the candidate questions as the questions in the target questionnaire, regenerating all the candidate questions, or abandoning all the candidate questions.

Specifically, the questionnaire processing region 207 may include a shortcut processing control, a third dialog window, and an auxiliary text presentation bar. The shortcut processing control is used for processing all the candidate questions. For example, the shortcut processing control can include a control that confirms all the candidate questions, a control that retries all the candidate questions, and a control that abandons all the candidate questions. A user can confirm, retry, or abandon all the candidate questions by triggering the shortcut processing control.

The third dialog window is used for receiving text inputted by a user. The text inputted by the user can be used for indicating processing operations for all the candidate questions. For example, a user can enter “Keep the first, second, and third questions, and regenerate the fourth question” in the third dialog window, indicating that the first, second, and third questions will be determined as the questions in the target questionnaire and the fourth question will be regenerated.

The auxiliary text presentation bar is used for presenting at least one piece of auxiliary text. The auxiliary text can be used for assisting a user in entering the text indicating the processing operations for all the candidate questions. For example, the auxiliary text can include “Generate more questions”, “Generate a more detailed questionnaires”, or “Generate a shorter questionnaire”. A user can select the auxiliary text presented in an auxiliary text box, and enter, based on the auxiliary text, the text indicating the processing operation for all the candidate questions. This facilitates the questionnaire generation tool to understand the intention of the user and generate a target questionnaire that is more in line with the need of the user.

Similarly, a user can process a candidate question separately. As shown in FIG. 2D, the questionnaire generation page 20 includes a dialog window 201, a candidate question presentation region 204, and a candidate question processing region 208. The candidate question processing region 208 is used for processing a candidate question separately, such as determining a candidate question as the question in the target questionnaire, regenerating a candidate question, or abandoning a candidate question.

Specifically, the candidate question processing region 208 may include a shortcut processing control, a fourth dialog window, and an auxiliary text presentation bar. The shortcut processing control is used for processing a candidate question. For example, the shortcut processing control can include a control that confirms a candidate question, a control that retries a candidate question, and a control that abandons a candidate question. A user may confirm, retry, or abandon a candidate question by triggering the shortcut processing control.

The fourth dialog window is used for receiving text inputted by a user. The text inputted by the user may be used for indicating processing operations for a candidate question. For example, a user may enter “Regenerate more detailed second question” in the fourth dialog window, instructing to regenerate the second question.

The auxiliary text presentation bar is used for presenting at least one piece of auxiliary text. The auxiliary text may be used for assisting a user in entering the text indicating the processing operations for a candidate question. For example, the auxiliary text may include “Add options” or “Reduce options”. A user may select the auxiliary text presented in an auxiliary text box, and enter, based on the auxiliary text, the text indicating the processing operation for a candidate question. This facilitates the questionnaire generation tool to understand the intention of the user and generate a candidate question that is more in line with the need of the user.

After the questions of the target questionnaire are determined, the target questionnaire may be presented to the user. As shown in FIG. 2F, the questionnaire generation page 20 includes a questionnaire presentation region 209. The questionnaire presentation region 209 is used for presenting the questions of the target questionnaire. Different title types of questions may be presented according to corresponding presentation rules. For example, for a question with the title type indicating single-choice question or multiple-choice question, a title and a plurality of options may be presented. Further, a single-choice question and a multiple-choice question can be presented in different presentation effects. For example, a check box of the single-choice question may be a circle, and a check box of the multiple-choice question can be square.

After the questions of the target questionnaire are determined, a corresponding target table may be further generated. The target table may be as shown in Table 1:

TABLE 1

| | | Have an | Favorite |
|---|---|---|---|
| Submission | | experience in | programming |
| time | Submitter | programming or not | language |
| Jul. 10, 2023 | A | Yes | Python |

It can be seen from Table 1 that field names of the fields in the target table correspond to the titles of the questions in the target questionnaire; and field types of the fields in the target table correspond to title types of the questions in the target questionnaire (Not all the fields are shown in Table 1). In addition, the target table may further include fields used for compiling questionnaire results, namely a submission time field and a submitter field. In this way, the questionnaire results of the target questionnaire may be compiled through the target table, achieving efficient questionnaire management.

The questionnaire generation method provided by this embodiment of the present application has been described in detail above in conjunction with FIG. 1 to FIG. 2. The following will describe a system and a device provided by the embodiments of the present application in conjunction with the accompanying drawings.

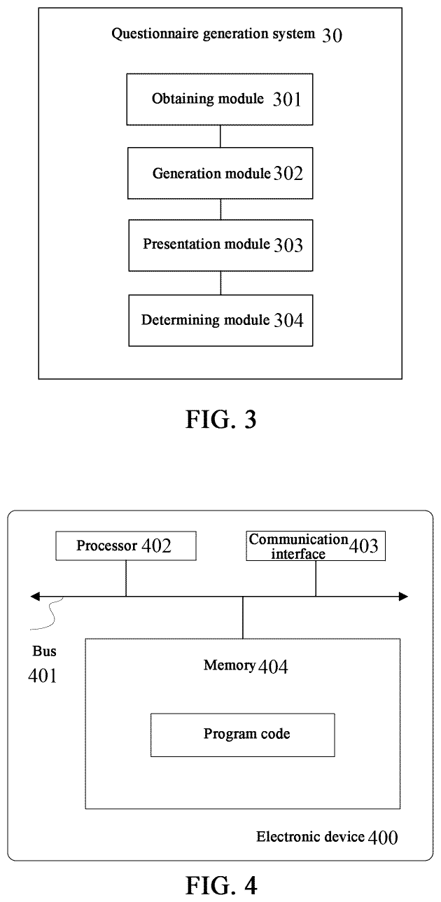

FIG. 3 is a schematic structural diagram of a questionnaire generation system. The system 30 includes:
an obtaining module 301, configured to obtain, in response to a generation triggering operation for a questionnaire generation page, text to be processed inputted by a user in a dialog window, wherein the dialog window is used for receiving content inputted by the user, and the text to be processed is used for instructing to generate a target questionnaire;
a generation module 302, configured to generate at least one candidate question according to the text to be processed;
a presentation module 303, configured to present the at least one candidate question on the questionnaire generation page, wherein the candidate question includes a title and an answer option corresponding to the title; and
a determining module 304, configured to: use, in response to a confirming operation for a target candidate question among the at least one candidate question, the target candidate question as at least one question of the target questionnaire.

In some possible implementations, the obtaining module 301 is specifically configured to:
obtain, in response to a triggering operation for the dialog window in the questionnaire generation page, the text to be processed inputted by the user in the dialog window; or
present the dialog window on the questionnaire generation page in response to a triggering operation for a dialog control on the questionnaire generation page; and
obtain the text to be processed inputted by the user in the dialog window.

In some possible implementations, the generation module 302 is specifically configured to:
input the text to be processed to a question generation model, and generate the at least one candidate question.

In some possible implementations, the presentation module 303 is specifically configured to:
present the title of the at least one candidate question on the questionnaire generation page, and present the answer option, corresponding to the title, of the at least one candidate question on the questionnaire generation page according to a title type of the title and a presentation rule corresponding to the title type.

In some possible implementations, the generation module 302 is further configured to:
generate a target table according to the target questionnaire, wherein the target table is used for compiling questionnaire results of the target questionnaire, and fields of the target table correspond to the questions of the target questionnaire.

In some possible implementations, the generation module 302 is specifically configured to achieve that:
field names of the fields in the target table correspond to the titles of the questions in the target questionnaire; and
field types of the fields in the target table correspond to title types of the questions in the target questionnaire.

In some possible implementations, the system 30 further includes:
an update module, configured to update, in response to a revise operation for the field name of a target field in the target table, the title of a target question, corresponding to the target field, in the target questionnaire; or, update, in response to a revise operation for a field attribute of a target field in the target table, an answer option of a target question, corresponding to the target field, in the target questionnaire.

In some possible implementations, the obtaining module 301 is specifically configured to:
in response to the generation triggering operation for the questionnaire generation page, obtain first text to be processed inputted by the user in a first dialog window, wherein the first text to be processed is used for instructing to generate a target questionnaire, and the first dialog window is located in a first region of the questionnaire generation page;
the generation module 302 is specifically configured to:
generate at least one first candidate question according to the first text to be processed, and present the at least one first candidate question on the questionnaire generation page;
the obtaining module 301 is further configured to:
in response to the generation triggering operation for the questionnaire generation page, obtain second text to be processed inputted by the user in a second dialog window, wherein the second text to be processed is used for instructing to generate candidate questions, and the second dialog window is located in a second region of the questionnaire generation page; and
the generation module 302 is further configured to:
generate a second candidate question according to the second text to be processed and the at least one first candidate question.

In some possible implementations, the generation module 302 is further configured to:
regenerate, in response to a retry operation for the at least one candidate question in the dialog window, the at least one candidate question, and present the at least one regenerated question on the questionnaire generation page.

In some possible implementations, the generation module 302 is specifically configured to:
regenerate, in response to a triggering operation for a retry control in the dialog window, the at least one candidate question; or,
obtain third text to be processed inputted by the user in the dialog window, wherein the third text to be processed is used for instructing to regenerate the candidate question; and
regenerate the at least one candidate question according to the third text to be processed.

The questionnaire generation system 30 according to the embodiments of the present application may correspond to the execution of the method according to the embodiments of the present application, and the above and other operations and/or functions of the various modules/units of the questionnaire generation system 30 are respectively designed to implement the corresponding processes of the various methods in the embodiment shown in FIG. 1. For simplicity, they will not be elaborated here.

The embodiments of the present application further provide an electronic device. The electronic device is specifically configured to achieve the functions of the questionnaire generation system 30 in the embodiment shown in FIG. 3.

FIG. 4 shows a schematic structural diagram of an electronic device 400. As shown in FIG. 4, the electronic device 400 includes a bus 401, a processor 402, a communication interface 403, and a memory 404. The processor 402, the memory 404, and the communication interface 403 communicate with each other through the bus 401.

The bus 401 can be a peripheral component interconnect (PCI) bus, an extended industry standard architecture (EISA) bus, or the like. The bus may be divided into an address bus, a data bus, a control bus, and the like. For ease of representation, only one thick line is used in FIG. 4, but it does not mean that there is only one bus or one type of bus.

The processor 402 can be one or more of a central processing unit (CPU), a graphics processing unit (GPU), a microprocessor (MP), or a digital signal processor (DSP).

The communication interface 403 is used for external communication. For example, the communication interface 403 can be used for communicating with a terminal.

The memory 404 may include a volatile memory, such as a random access memory (RAM). The memory 404 may further include a non-volatile memory, such as a read-only memory (ROM), a flash memory, a hard disk drive (HDD), or a solidstate drive (SSD).

The memory 404 has executable codes stored thereon, and the processor 402 executes the executable codes to perform the aforementioned questionnaire generation method.

Specifically, in a case of implementing the embodiment shown in FIG. 3, and in a case that the various modules or units of the questionnaire generation system 30 described in the embodiment of FIG. 3 are implemented through software, the software or program codes required to execute the functions of the various modules/units in FIG. 3 may be partially or entirely stored in the memory 404. The processor 402 runs the program codes corresponding to the various units stored in the memory 404 and performs the aforementioned questionnaire generation method.

The embodiments of the present application further provide a computer-readable storage medium. The computer-readable storage medium may be any usable medium that can be stored by a computing device, or a data storage device such as a data center including one or more usable media. The usable medium may be a magnetic medium (for example, a floppy disk, a hard disk drive, or a magnetic tape), an optical medium (for example, a DVD), a semiconductor medium (for example, a Solid State Disk), or the like. The computer-readable storage medium includes instructions. The instructions instruct the computing device to perform the above questionnaire generation method applied to the questionnaire generation system 30.

The embodiments of the present application further provide a computer program product. The computer program product includes one or more computer instructions. When the computer instructions are loaded and executed on a computing device, the processes or functions according to the embodiments of the present application are all or partially generated.

The computer instructions may be stored in a computer-readable storage medium or may be transmitted from one computer-readable storage medium to another computer-readable storage medium. For example, the computer instructions may be transmitted from a website, a computer, or a data center to another website, computer, or data center in a wired manner (for example, by using a coaxial cable, an optical fiber, or a digital subscriber line (DSL)) or a wireless (for example, infrared, radio, or microwave) manner.

When the computer program product is run by a computer, the computer performs any of the aforementioned questionnaire generation methods The computer program product can be a software installation package. In a case that any of the foregoing questionnaire generation methods needs to be used, the computer program product can be downloaded and is run on the computer.

The flowcharts and block diagrams in the accompanying drawings illustrate possible system architectures, functions, and operations that may be implemented by a system, a method, and a computer program product according to the various embodiments of the present application. In this regard, each block in a flowchart or a block diagram may represent a module, a program, or a part of a code. The module, the program, or the part of the code includes one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also be noted that each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The units/modules described in the embodiments of the present application can be implemented through software or hardware. The names of the units/modules do not constitute a limitation on the units in a situation.

The functions described herein above may be performed, at least in part, by one or a plurality of hardware logic components. For example, nonrestrictive, example hardware logic components that can be used include: a Field Programmable Gate Array (FPGA), an Application Specific Integrated Circuit (ASIC), Application Specific Standard Parts (ASSP), a System on Chip (SOC), a Complex Programmable Logic Device (CPLD), and the like.

In the context of this embodiment of the present application, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable medium may include an electrical connection based on one or more wires, a portable computer disk, a hard disk drive, a RAM, a ROM, an EPROM or flash memory, an optical fiber, a CD-ROM, an optical storage device, a magnetic storage device, or any suitable combinations of the above contents.

It should be noted that the various embodiments in this specification are described in a progressive manner, and each embodiment focuses on differences from other embodiments. The same and similar parts between all the embodiments can be referred to each other. Since the system or apparatus disclosed in the embodiments correspond to the method disclosed in the embodiments, the apparatus is described simply, and related parts are found in some of the explanations of the method.

It should be understood that in the present application, “at least one” means one or more, and “plurality” means two or more. The term “and/or” is used for describing an association relationship of related objects, indicating that there are three types of relationships. For example, “A and/or B” can represent: only A exists, only B exists, and A and B exist simultaneously, where A and B can be singular or plural. The character “/” usually indicates an “or” relation between associated objects. The term “at least one of the following items” or its similar expression means any combination of these items, including any combination of a single item or a plurality of items. For example, at least one of a, b, or c can represent: a, b, c, “a and b”, “a and c”, “b and c”, or “a and b and c”, where a, b, and c can be singular or plural.

It should be further noted that in this document, relationship terms such as first and second are used solely to distinguish one entity or operation from another entity or operation without necessarily requiring or implying any actual such relationship or order between such entities or operations. Furthermore, the terms “includes”, “including”, or any other variation thereof, are intended to encompass a non-exclusive inclusion, such that a process, method, article, or device that includes a list of elements does not include only those elements but may include other elements not explicitly listed or inherent to such process, method, article, or device. Without further limitation, an element defined by the phrase “including a/an . . . ” does not exclude the presence of another identical element in the process, method, article or device that includes the element.

The steps of the method or algorithm described in conjunction with the embodiments disclosed herein can be implemented directly using hardware, software modules executed by the processor, or a combination thereof. The software modules can be placed in a RAM, an internal memory, a ROM, an EPROM, EEPROM, a register, a hard disk drive, a removable disk, a CD-ROM, or a storage medium in any other form known in the technical field.

The above explanations of the disclosed embodiments enable those skilled in the art to implement or use the present application. The various modifications to these embodiments will be apparent to those skilled in the art, and the general principles defined herein can be implemented in other embodiments without departing from the spirit or scope of the present application. Thus, the present invention is not limited to these embodiments shown herein, but accords with the broadest scope consistent with the principles and novel features disclosed herein.

I/We claim:

1. A method for questionnaire generation, comprising:
obtaining, in response to a generation triggering operation for a questionnaire generation page, a text to be processed inputted by a user in a dialog window, wherein the dialog window is used for receiving content inputted by the user, and the text to be processed is used for instructing to generate a target questionnaire;
generating at least one candidate question according to the text to be processed, and presenting the at least one candidate question on the questionnaire generation page, wherein the candidate question comprises a title and an answer option corresponding to the title; and
using, in response to a confirming operation for a target candidate question among the at least one candidate question, the target candidate question as at least one question of the target questionnaire.

2. The method of claim 1, wherein obtaining, in response to a generation triggering operation for a questionnaire generation page, a text to be processed inputted by a user in a dialog window comprises:
obtaining, in response to a triggering operation for the dialog window in the questionnaire generation page, the text to be processed inputted by the user in the dialog window; or
presenting, in response to a triggering operation for a dialog control on the questionnaire generation page, the dialog window on the questionnaire generation page; and
obtaining the text to be processed inputted by the user in the dialog window.

3. The method of claim 1, wherein generating at least one candidate question according to the text to be processed comprises:
inputting the text to be processed to a question generation model to generate the at least one candidate question.

4. The method of claim 1, wherein presenting the at least one candidate question on the questionnaire generation page comprises:
presenting the title of the at least one candidate question on the questionnaire generation page, and presenting the answer option corresponding to the title of the at least one candidate question on the questionnaire generation page according to a title type of the title and a presentation rule corresponding to the title type.

5. The method of claim 1, wherein the method further comprises:
generating a target table according to the target questionnaire, wherein the target table is used for compiling questionnaire results of the target questionnaire, and fields of the target table correspond to questions of the target questionnaire.

6. The method of claim 5, wherein fields of the target table correspond to questions of the target questionnaire, comprises:
field names of the fields in the target table correspond to titles of the questions in the target questionnaire; and
field types of the fields in the target table correspond to title types of the questions in the target questionnaire.

7. The method of claim 6, wherein the method further comprises:
updating, in response to a revise operation for a field name of a target field in the target table, a title of a target question corresponding to the target field in the target questionnaire; or
updating, in response to a revise operation for a field attribute of the target field in the target table, an answer option of the target question corresponding to the target field in the target questionnaire.

8. The method of claim 1, wherein obtaining, in response to a generation triggering operation for a questionnaire generation page, a text to be processed inputted by a user in a dialog window comprises:
obtaining, in response to the generation triggering operation for the questionnaire generation page, a first text to be processed inputted by the user in a first dialog window, wherein the first text to be processed is used for instructing to generate a target questionnaire, and the first dialog window is located in a first region of the questionnaire generation page;
generating at least one candidate question according to the text to be processed, and presenting the at least one candidate question on the questionnaire generation page comprises:
generating at least one first candidate question according to the first text to be processed, and presenting the at least one first candidate question on the questionnaire generation page;
the method further comprises:
obtaining, in response to the generation triggering operation for the questionnaire generation page, a second text to be processed inputted by the user in a second dialog window, wherein the second text to be processed is used for instructing to generate candidate questions, and the second dialog window is located in a second region of the questionnaire generation page; and
generating a second candidate question according to the second text to be processed and the at least one first candidate question.

9. The method of claim 1, wherein the method further comprises:
regenerating, in response to a retry operation for the at least one candidate question in the dialog window, the at least one candidate question, and presenting the at least one regenerated question on the questionnaire generation page.

10. The method of claim 9, wherein regenerating, in response to a retry operation for the at least one candidate question in the dialog window, the at least one candidate question comprises:
regenerating, in response to a triggering operation for a retry control in the dialog window, the at least one candidate question; or
obtaining a third text to be processed inputted by the user in the dialog window, wherein the third text to be processed is used for instructing to regenerate the candidate question; and
regenerating the at least one candidate question according to the third text to be processed.

11. An electronic device, wherein the electronic device comprises a processor and a memory,
wherein the processor is configured to execute instructions stored in the memory to cause the electronic device to:
obtain, in response to a generation triggering operation for a questionnaire generation page, a text to be processed inputted by a user in a dialog window, wherein the dialog window is used for receiving content inputted by the user, and the text to be processed is used for instructing to generate a target questionnaire;
generate at least one candidate question according to the text to be processed, and presenting the at least one candidate question on the questionnaire generation page, wherein the candidate question comprises a title and an answer option corresponding to the title; and
use, in response to a confirming operation for a target candidate question among the at least one candidate question, the target candidate question as at least one question of the target questionnaire.

12. The electronic device of claim 11, wherein the electronic device is further caused to obtain, in response to a generation triggering operation for a questionnaire generation page, a text to be processed inputted by a user in a dialog window by:
obtaining, in response to a triggering operation for the dialog window in the questionnaire generation page, the text to be processed inputted by the user in the dialog window; or
presenting, in response to a triggering operation for a dialog control on the questionnaire generation page, the dialog window on the questionnaire generation page; and
obtaining the text to be processed inputted by the user in the dialog window.

13. The electronic device of claim 11, wherein the electronic device is caused to generate at least one candidate question according to the text to be processed by:
inputting the text to be processed to a question generation model to generate the at least one candidate question.

14. The electronic device of claim 11, wherein the electronic device is caused to present the at least one candidate question on the questionnaire generation page by:
presenting the title of the at least one candidate question on the questionnaire generation page, and presenting the answer option corresponding to the title of the at least one candidate question on the questionnaire generation page according to a title type of the title and a presentation rule corresponding to the title type.

15. The electronic device of claim 11, wherein the electronic device is further caused to:
generate a target table according to the target questionnaire, wherein the target table is used for compiling questionnaire results of the target questionnaire, and fields of the target table correspond to questions of the target questionnaire.

16. The electronic device of claim 15, wherein fields of the target table correspond to questions of the target questionnaire, comprises:
field names of the fields in the target table correspond to titles of the questions in the target questionnaire; and
field types of the fields in the target table correspond to title types of the questions in the target questionnaire.

17. The electronic device of claim 16, wherein the electronic device is further caused to:
update, in response to a revise operation for a field name of a target field in the target table, a title of a target question corresponding to the target field in the target questionnaire; or
update, in response to a revise operation for a field attribute of the target field in the target table, an answer option of the target question corresponding to the target field in the target questionnaire.

18. The electronic device of claim 11, wherein the electronic device is further caused to obtain, in response to a generation triggering operation for a questionnaire generation page, a text to be processed inputted by a user in a dialog window by:
obtaining, in response to the generation triggering operation for the questionnaire generation page, a first text to be processed inputted by the user in a first dialog window, wherein the first text to be processed is used for instructing to generate a target questionnaire, and the first dialog window is located in a first region of the questionnaire generation page;
generating at least one candidate question according to the text to be processed, and presenting the at least one candidate question on the questionnaire generation page comprises:
generating at least one first candidate question according to the first text to be processed, and presenting the at least one first candidate question on the questionnaire generation page;
the electronic device is further caused to:
obtain, in response to the generation triggering operation for the questionnaire generation page, a second text to be processed inputted by the user in a second dialog window, wherein the second text to be processed is used for instructing to generate candidate questions, and the second dialog window is located in a second region of the questionnaire generation page; and
generate a second candidate question according to the second text to be processed and the at least one first candidate question.

19. The electronic device of claim 11, wherein the electronic device is further caused to:
regenerate, in response to a retry operation for the at least one candidate question in the dialog window, the at least one candidate question, and presenting the at least one regenerated question on the questionnaire generation page.

20. A non-transitory computer-readable storage medium, comprising instructions, wherein the instructions instruct an electronic device to:
obtain, in response to a generation triggering operation for a questionnaire generation page, a text to be processed inputted by a user in a dialog window, wherein the dialog window is used for receiving content inputted by the user, and the text to be processed is used for instructing to generate a target questionnaire;
generate at least one candidate question according to the text to be processed, and presenting the at least one candidate question on the questionnaire generation page, wherein the candidate question comprises a title and an answer option corresponding to the title; and
use, in response to a confirming operation for a target candidate question among the at least one candidate question, the target candidate question as at least one question of the target questionnaire.
